(19) United States
(12) Patent Application Publication
(10) Pub. No.: US 2012/0151145 A1
(43) Pub. Date: Jun. 14, 2012

(54) Data Driven Micro-Scheduling of the Individual Processing Elements of a Wide Vector SIMD Processing Unit

(75) Inventor: Alexander M. LYASHEVSKY, Cupertino, CA (US)

(73) Assignee: Advanced Micro Devices, Inc., Sunnyvale, CA (US)

(21) Appl. No.: 12/966,808

(22) Filed: Dec. 13, 2010

(51) Int. Cl. G06F 15/80; G06F 9/02; G06F 12/08

(52) U.S. Cl. 711/125; 712/22; 711/E12.017; 712/E09.002

(57) ABSTRACT

A method for optimizing processing in a SIMD core. The method comprises processing units of data within a working domain, wherein the processing includes one or more working items executing in parallel within a persistent thread. The method further comprises retrieving a unit of data from within a working domain, processing the unit of data, retrieving other units of data when processing of the unit of data has finished, processing the other units of data, and terminating the execution of the working items when processing of the working domain has finished.

### BACKGROUND

1. Field

The present invention generally relates to processing data using single instruction multiple data (SIMD) cores.

2. Background Art

In many applications, such as graphics processing, a sequence of threads process one or more data items in order to output a final result. In many modern parallel processors, for example, simplified arithmetic-logic units (“ALUs”) within a SIMD core synchronously execute a set of working items. Typically, the synchronous executing working items are identical (i.e., have the identical code base). A plurality of identical synchronous working items that execute on separate processors are known as, or called, a wavefront or warp.

During processing, one or more SIMD cores concurrently execute multiple wavefronts. Execution of the wavefront terminates when all working items, within the wavefront, complete processing. Each wavefront includes multiple working items are processed in parallel, using the same set of instructions. Generally, the time required for each working item to complete processing depends on a criterion determined by data. As such, the working items can complete processing at different times. When the processing of all working item has been completed, the SIMD core finishes processing a wavefront.

Because the SIMD core has to wait for all of the working items to finish, processing cycles are wasted. This results in inefficiencies and sub-optimal performance within the SIMD core. It also results in a decrease in the overall performance of the associated graphics processing unit (“GPU”).

Thus, what is needed are systems and methods that optimize processing such that all simplified ALUs within SIMD cores remain busy as working items are being processed.

### BRIEF SUMMARY OF EMBODIMENTS OF THE INVENTION

Embodiments of the invention include a method for optimizing processing in a SIMD core. The method comprises processing units of data within a working domain, wherein the processing includes one or more working items executing in parallel within a persistent thread. The method further comprises retrieving a unit of data from within a working domain, processing the unit of data, retrieving other units of data when processing of the unit of data has finished, processing the other units, and terminating the execution of the working items when processing of the working domain has finished.

Another embodiment is a system for optimizing data processing, comprising a SIMD core configured to process units of data within a working domain, wherein the one or more working items within a persistent thread process the units of data in parallel. The system further configured to retrieve a unit of data from within a working domain using each working item, processes the unit of data, retrieve other units of data when processing of the unit of data has finished, processes the other units, and terminate the execution of the working items when processing of the working domain has finished.

Yet another embodiment is a computer-readable medium storing instructions wherein said instructions, when executed, are adapted for optimizing processing in a SIMD core. The method comprises processing units of data within a working domain, wherein the processing includes one or more working items executing in parallel within a persistent thread. The method further comprises retrieving a unit of data from within a working domain using each working item, processing the unit of data, retrieving other units of data when processing of the unit of data has finished, processing the other units, and terminating the execution of the working items when processing of the working domain has finished.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the pertinent art to make and use embodiments of the invention.

FIG. 1 shows a block diagram 100 of a computing environment.

FIG. 2 is a flowchart 200 illustrating an exemplary embodiment of SIMD 126 processing working domain using one or more persistent threads.

FIG. 3 is flowchart 300 of an exemplary embodiment of the working item processing units of data on SIMD 126.

FIG. 4 shows a block diagraph 400 of a computing environment, according to an embodiment of the present invention.

The present invention will be described with reference to the accompanying drawings. Generally, the drawing in which an element first appears is typically indicated by the leftmost digit(s) in the corresponding reference number.

### DETAILED DESCRIPTION OF EMBODIMENTS OF THE INVENTION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

### SIMD System Overview

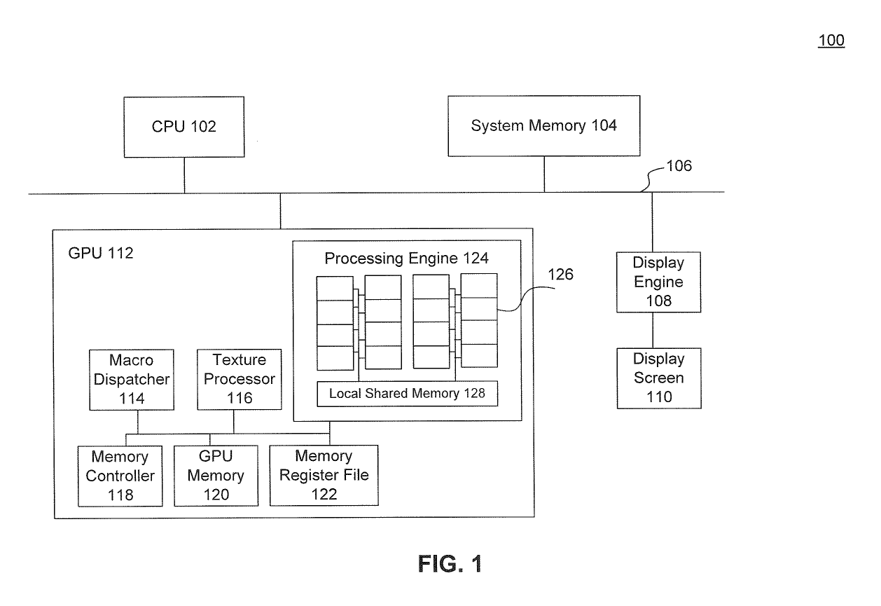

FIG. 1 is a block diagram of a computing environment 100. Computing environment 100 includes a central processing unit (“CPU”) 102, a system memory 104, a communication infrastructure 106, a display engine 108, a display screen 110 and a GPU 112. As will be appreciated, the various components 102, 104, 106, 108 and 112 can be combined into various combinations. For example, CPU 102 and GPU 112 could be included in a single device (e.g., a single component) or even on a single integrated circuit.

In a computing environment 100, data processing is divided between CPU 102 and GPU 112. CPU 102 processes computation instructions, application and control commands, and performs arithmetical, logical, control and input/output operations for computing environment 100. CPU 102 is proficient at handling control and branch-like instructions.

System memory 104 stores commands and data processed by CPU 102 and GPU 112. CPU 102 reads and writes data into system memory 104. Similarly, when GPU 112 requests data from CPU 102, CPU 102 retrieves the data from system memory 104 and loads the data onto a GPU memory 120.

Display engine 108 displays data that is processed by CPU 102 and GPU 112 on a display screen 110. Display engine 108 can be implemented in hardware and/or software or as a combination thereof, and may include functionality to optimize the display of data to the specific characteristics of display screen 110. Display engine 108 retrieves processed data from system memory 104 or directly from GPU memory 120. Display screen 110 displays data received form display engine 108 to a user.

The various devices of computing system 100 are coupled by a communication infrastructure 106. For example, communication infrastructure 106 can include one or more communication buses including a Peripheral Component Interconnect Express (PCI-E) bus, Ethernet, FireWire, and/or other interconnection device.

GPU 112 receives data related tasks from CPU 102. In an embodiment, GPU 112 processes heavily computational and mathematically intensive tasks that require high-speed, parallel computing. GPU 112 is operable to perform parallel computing using 100s or 1000s of threads.

GPU 112 includes a macro dispatcher 114, a texture processor 116, a memory controller 118, a GPU memory 120, a GPU memory register 122 and a GPU processor 124. Macro dispatcher 114 controls the command execution on GPU 112. For example, macro dispatcher 114 receives commands and data from CPU 102 and coordinates the command and data processing on GPU 112. When CPU 102 sends an instruction to process data, macro dispatcher 114 forwards the instruction to GPU processor 124. When macro dispatcher 114 receives a texture request, macro dispatcher 114 forwards the texture request to texture processor 116. Macro dispatcher 114 also controls and coordinates memory allocation on GPU 112 through memory controller 118.

Texture processor 116 functions as a memory address calculator. When texture processor 116 receives a request for memory access from macro dispatcher 116, texture processor 116 calculates the memory address that accesses data from GPU memory 120. After texture processor 116 calculates the memory address, it sends the request and the calculated memory address to memory controller 118.

Memory controller 118 controls access to GPU memory 120. When memory controller 118 receives a request from texture processor 116, memory controller 118 determines the request type and proceeds accordingly. If memory controller 118 receives a write request, it writes the data into GPU memory 120. If memory controller 118 receives a read request, memory controller 118 reads the data from memory 120 and either loads the data into the register file 122 or sends the data to CPU 102 using communication infrastructure 106.

GPU memory 120 stores data on GPU 112. In an embodiment, GPU memory 120 receives data from system memory 104. GPU memory 120 stores data that was processed by GPU processor 124.

GPU processor 124 is a high-speed parallel processing engine. GPU processor 124 includes multiple SIMD cores, such as SIMD 126, and a local shared memory 128. SIMD 126 is a simple, high-speed processor that performs high-speed data computations in parallel. SIMD 126 includes ALUs for executing data.

SIMD 126 processes data or instructions as scheduled by macro dispatcher 114. In one embodiment, SIMD 126 processes data as a wavefront (also known as a hardware thread). Each wavefront is processed sequentially by SIMD 126, and as noted above, includes multiple working items. Each working item is assigned a unit of data to process. SIMD 126 processes the working items in parallel and with the same set of instructions. The wavefront terminates when all working items complete executing their assigned units of data. A person skilled in the art will appreciate that the term “working items” is an industry term set forth by the OpenCL hardware programming language.

A program counter shared by all working items in the wavefront enables the working items to execute in parallel. The program counter increments instructions that are executed by SIMD 126 and synchronizes the ALUs, which process the working items.

Wavefronts process data stored in system memory 104 or GPU memory 120 (collectively referred to as memory). The data stored in memory and processed by GPU 112 is called “input data”. Input data is logically divided into multiple and discrete, units of data. A working domain includes units of data that require processing using one or more wavefronts. Input data may comprise one or more working domains.

Prior to SIMD 126 executing a wavefront, units of data are loaded from system memory 104 or GPU memory 120 into register file 122. Register file 122 is a local memory which receives units of data which are being processed by SIMD 126. SIMD 126 reads units of data from register file 122 and process the data.

When working items begin to execute on SIMD 126, they share memory space in local shared memory 128. The working items use local shared memory to communicate and pass information among each other. For example, the working items share information when one working item writes into a register and another working item reads from the same register. When a working item writes to local shared memory 128, remaining working items in a wavefront are synchronized to read from local shared memory 128 so that all working items have the same information.

Local shared memory 128 includes an addressable memory space, such as a DRAM memory, that enables high-speed read and write access for ALUs.

In an embodiment, one or more wavefronts comprise a wavefront group (also referred to as a group). A person skilled in the art will appreciate that the group is a term set forth in the OpenCL programming language. The working items in the group share memory in local shared memory 128 and communicate among each other.

A kernel is a unit of software programmed by an application developer to manipulate behavior of the hardware and/or input/output functionality, for example, on GPU 112. In some embodiments, a kernel can be programmed to manipulate data scheduling, generally, and units of data, specifically, that are processed by working items. An application developer writes code for a kernel in a variety of programming languages, such as, for example, OpenCL, C, C++, Assembly or the like.

GPU 112 can be coupled to additional components such as memories and displays. GPU 112 can also be a discrete component (i.e., separate device), integrated component (e.g., integrated into a single device such as a single integrated circuit (IC)), a single package housing multiple ICs, or integrated into other ICs—e.g., a CPU or a Northbridge, for example.

### SIMD Processing Using a Persistent Thread

In the illustrative embodiment of FIG. 1, GPU 112 is a multi-thread device capable of processing 100s or 1000s of wavefronts. In a conventional GPU, when a SIMD processes a wavefront, each working item processes one unit of data. When all working items complete processing the corresponding units of data the wavefront terminates. After the wavefront terminates, a macro dispatcher initiates another wavefront on the SIMD. Because the time required to process data by each working item can depend on the criteria in the unit of data, each working item in the wavefront can complete execution at a different time. This results in wasted SIMD cycles, increased idle time and decreased throughput because the ALUs which have completed processing continue to spin and wait until all working items complete execution.

In some conventional GPUs, when working items in a wavefront execute the following code segment:

for (i=0; i<=x; i++){ }

where “x” is an integer set by the data in the units of data, and “i” is a counter which is incremented with each iteration. The time required for the working item to complete processing is defined by “x”. As a result, when “x” is set to an integer in one working item, that is considerably higher than the integers in the remaining working items, the corresponding ALU continues to process the working item, while the remaining ALUs have finished and remain idle. When the last working item completes execution, the wavefront terminates and the SIMD is able to process another wavefront. As understood by a person skilled in the art “x” may be any type of criterion in any code segment where data determines when a working item completes processing.

In one embodiment of the present invention, a kernel, and not macro dispatcher 114, schedules data processing on GPU 112. A kernel schedules data processing by instantiating persistent threads. In a persistent thread, the working items remain alive until all units of data in a working domain are processed. Because the working items remain alive, the wavefront does not terminate until all units of data are processed.

In a persistent thread, when a working item completes executing one unit of data, the working item retrieves another unit of data from memory and continues to execute the second unit of data. As a result, SIMD 126 does not remain idle, but is more fully utilized until it finishes processing the entire working domain.

Applying the previous example to embodiments of the present invention:

for (i=0; i<=x; i++){ }

when a working item receives a data unit where “x” is set to a value that is large compared to the values of “x” in other working items, the working items that complete processing their data units on their respective ALUs, retrieve another unit(s) of data from memory and continues to process data.

For example, below is a code segment of a kernel executing a persistent thread:

```
Kernel_balanced(int thread_id)
{
      bool thread_exit,
      bool exit_data_processing;
      long data_item_id;
      exit_data_processing = 1;
      thread_exit = 0;
      do {
        if (exit_data_processing) {
          thread_exit = consume_next_input_data_item
                      (&data_item_id , thread_id);
          If (thread_exit) { break; }
          Setup(data_item_id);
        }
        exit_data_processing = Process(data_item_id);
      } while(!thread_exit)
}
```

Unlike conventional systems were the kernel is called once for each working item processing one data unit, in accordance with the illustrative embodiment of FIG. 1, the kernel is called as many times as there are working items. When an instance of a kernel is executed by computing environment 100, the kernel receives a parameter that identifies the working item that is going to process the units of data. The kernel also receives a parameter which identifies the number of data units that comprise a working domain. The working domain is equal to the input data. In another embodiment, the working domain is equal to the subset of input data that is assigned to a persistent thread or a group.

The persistent thread is embodied in the “do-while” loop in the kernel. In the “do-while” loop, each working item continues to process units of data until the entire working domain is processed. The “do” section of the “do-while” loop includes a function which retrieves a unit of data from system memory 104 or GPU memory 120 or the like. In the example above, the function is “consume_next_input_data_item( ).” When the working items process all data units in the working domain, the consume_next_input_data_item( ) function returns a thread_exit parameter which enables the working item to exit the kernel and terminate.

When the persistent thread begins to execute on SIMD 126, local shared memory 128 stores the size of the working domain allocated to the working items. The working item determines which unit of data to process by incrementing a shared counter, up to the size of the working domain. The value of the shared counter corresponds to the position of the unit of data in memory. The working item retrieves the value of the shared counter and increments the shared counter in the atomic operation. A person skilled in the art will appreciate that an atomic operation guarantees individual access to the shared counter to each working item. Because each working item retrieves a unique value from the shared counter, each working item is guaranteed individual access to the unit of data.

Once the working item identifies that the value in the shared counter reached the size of the working domain, the working item determines that all units of data were processed and exits the kernel.

After a working item retrieves a unit of data, the working item proceeds to set up the unit of data for processing. For example, in the exemplary kernel above, the working item proceeds to the Setup( ) function. In the Setup( ) function, GPU 112 ensures that the unit of data is loaded into the register file 122 and the required registers are initialized for processing the unit of data by the ALU.

After the data unit is set up for processing, each working item begins to process the unit of data. In the exemplary kernel above, the working items proceed to the Process( ) function. The working items continue to process the corresponding units of data until one working items completes processing. When one working item completes processing, all working items exit the processing mode and access local shared memory 128. A person skilled in the art will appreciate that all working items exit the processing mode because all working items in the persistent thread execute the same series of instructions in parallel.

When the working items access local shared memory 128, all working items increment the shared counter using an atomic operation. The working item which completed processing the data unit increments the shared counter by 1 and retrieves the value that is used to calculate the position for the next unit of data. The remaining working items also increment the shared counter, but with a value of 0. The remaining working items, therefore, retain the unit of data which they were currently processing. After the working item which completed the processing retrieves another unit of data, all working items return to processing data.

When the value of the shared counter reaches the number of units of data in the working domain, the working item cannot retrieve any more units of data. In an embodiment, the working item completes processing by exiting the kernel. When all working items comprising the persistent thread exit the kernel, the wavefront completes execution, terminates, and frees SIMD 126 resources for processing another wavefront.

In various embodiments of the present invention, when multiple groups process data units in the working domain, the size of the working domain being processed by each group is provided as an argument to the kernel. When each working item in a group attempts to retrieve a data unit for processing, the address of the unit of data in memory is calculated based on the group identifier, supplied, for example by an OpenCL run-time environment, the size of the working domain, and the value of the shared counter belonging to the group.

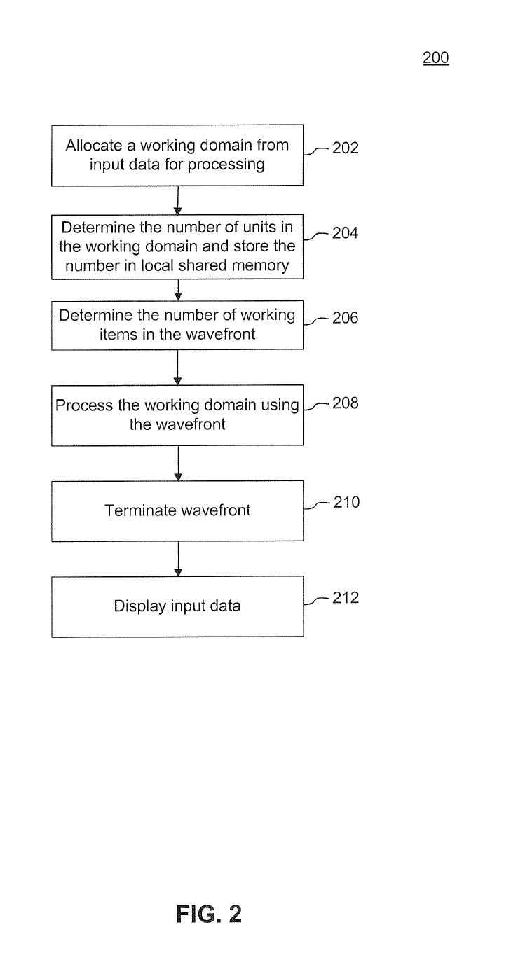

FIG. 2 is a flowchart illustrating an exemplary embodiment 200 of SIMD 126 processing working domain using one or more of the persistent thread. At step 202, GPU 112 allocates a working domain for processing. Input data includes several working domains and each working domain is processed by a group of persistent threads.

At step 204, GPU 112 determines the number of units in the working domain and stores the number in local shared memory 128. When SIMD 126 processes a persistent group, the group identifier is also stored in local shared memory 128. At step 206, GPU 112 determines the number of working items in a wavefront and requests a system call to instantiate a kernel for each working item. At step 208, each working item begins to process the units of data in the working domain using SIMD 126.

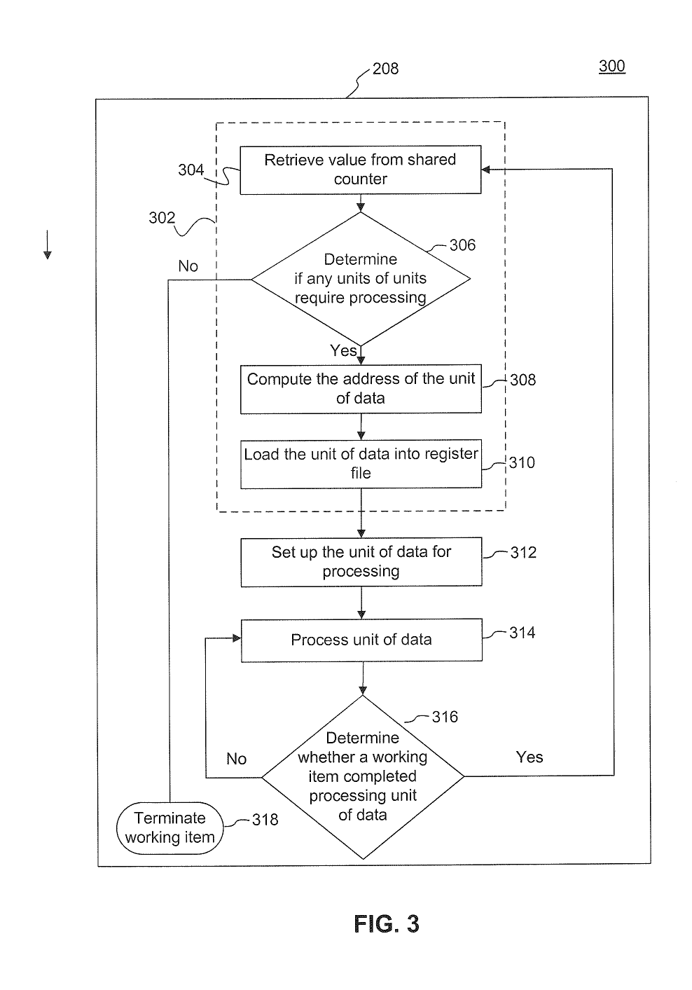

FIG. 3 is flowchart 300 of an exemplary embodiment of the working item processing units of data on SIMD 126. At step 302, each working item attempts to retrieve a unit of data. Steps 304-310 describe the retrieval process of step 302. In an embodiment, function consume_next_input_data_item( ) performs step 302.

At step 304, each working item retrieves a value from the shared counter. In an embodiment, the working item increments the shared counter using an atomic operation. If the working item already executes a unit of data, the working item does not increment the shared counter but retains the previous value.

At step 306, each working item uses the value from the shared counter to determine whether all units of data comprising a working domain have been processed or assigned to other working items. In a non-limiting embodiment, the determination in step 306 is made by comparing the value of the shared counter to the size of the working domain. If the working item determines that a unit of data that requires processing, the flow chart proceeds to step 308, otherwise the flowchart proceeds to step 318.

At step 308, each working item computes the memory address of the unit of data using the value retrieved in step 306. In an embodiment, when a working item belongs to a persistent group, the working item uses the identifier of the group and the value retrieved in step 306 to compute the memory address of the unit of data.

At step 310, the corresponding units of data are loaded into register file 122 from memory. At step 312, each working item sets up the data units for processing. In an embodiment, step 320 is performed using the Setup( ) function. At step 314, each working item begins to process the data units. In an embodiment step 316 is performed using the Process( ) function.

At step 316, one working item completes data processing and retrieves another unit of data as described in step 302. At step 318, the kernel completes execution and terminates the working item.

Returning back to FIG. 2, at step 210, all working items complete processing the unit of data and the wavefront terminates. At the optional step 212, the processed input data is displayed using the display engine 108 and display screen 110.

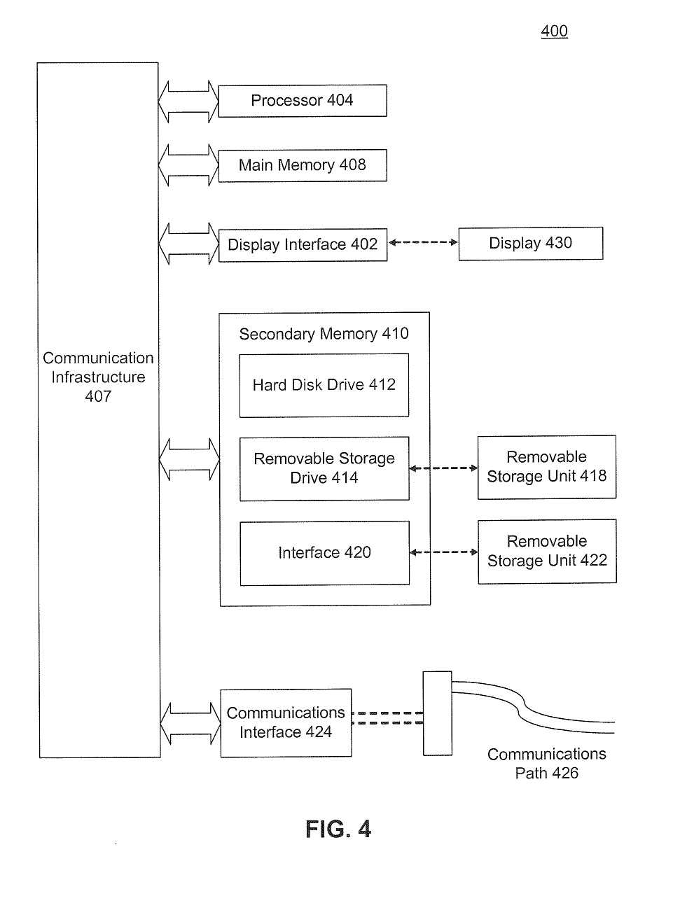

FIG. 4 illustrates an example computer system 400 in which embodiments of the present invention, or portions thereof, may be implemented as computer-readable code. For example, the system 100 implementing the CPU 102 and GPU 112 operating environment, may be implemented in computer system 400 using hardware, software, firmware, tangible computer readable media having instructions stored thereon, or a combination thereof, and may be implemented in one or more computer systems or other processing systems. Hardware, software, or any combination of such, may embody any of the modules and components in FIGS. 1-3.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 400. After reading this description, it will become apparent to a person skilled in the relevant art how to implement the invention using other computer systems and/or computer architectures. Although operations may be described as a sequential process, some of the operations may, in fact, be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 404 may be a special purpose or a general purpose processor device. As will be appreciated by persons skilled in the relevant art, processor device 104 may also be a single processor in a multi-core/multiprocessor system, such system operating alone, or in a cluster of computing devices operating in a cluster or server farm. Processor device 404 is connected to a communication infrastructure 406, for example, a bus, message queue, network, or multi-core message-passing scheme.

Computer system 400 also includes a main memory 408, for example, random access memory (RAM), and may also include a secondary memory 410. Secondary memory 410 may include, for example, a hard disk drive 412, removable storage drive 414. Removable storage drive 414 may comprise a floppy disk drive, a magnetic tape drive, an optical disk drive, a flash memory, or the like. The removable storage drive 414 reads from and/or writes to a removable storage unit 418 in a well-known manner. Removable storage unit 418 may comprise a floppy disk, magnetic tape, optical disk, etc. which is read by and written to by removable storage drive 414. As will be appreciated by persons skilled in the relevant art, removable storage unit 418 includes a computer-usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 may be in the form of signals, which may be electronic, electromagnetic, optical, or other signals capable of being received by communications interface 424. These signals may be provided to communications interface 424 via a communications path 426. Communications path 426 carries signals and may be implemented using wire or cable, fiber optics, a phone line, a cellular phone link, an RF link or other communications channels.

In this document, the terms “computer program medium” and “computer-usable medium” are used to generally refer to media such as removable storage unit 418, removable storage unit 422, and a hard disk installed in hard disk drive 412. Computer program medium and computer-usable medium may also refer to memories, such as main memory 408 and secondary memory 410, which may be memory semiconductors (e.g. DRAMs, etc.).

Computer programs (also called computer control logic) are stored in main memory 408 and/or secondary memory 410. Computer programs may also be received via communications interface 424. Such computer programs, when executed, enable computer system 400 to implement the present invention as discussed herein. In particular, the computer programs, when executed, enable processor device 404 to implement the processes of the present invention, such as the stages in the method illustrated by flowcharts 200 of FIG. 2 and 300 of FIG. 3 discussed above. Accordingly, such computer programs represent controllers of the computer system 400. Where the invention is implemented using software, the software may be stored in a computer program product and loaded into computer system 400 using removable storage drive 414, interface 420, and hard disk drive 412, or communications interface 424.

Embodiments of the invention may also be directed to computer program products comprising software stored on any computer-usable medium. Such software, when executed in one or more data processing devices, causes a data processing device(s) to operate as described herein. Embodiments of the invention employ any computer usable or readable medium. Examples of computer usable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage devices, etc.).

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present invention can be implemented by software, firmware, hardware (or hardware represented by software such, as for example, Verilog or hardware description language instructions), or a combination thereof. After reading this description, it will become apparent to a person skilled in the relevant art how to implement the invention using other computer systems and/or computer architectures.

It should be noted that the simulation, synthesis and/or manufacture of the various embodiments of this invention can be accomplished, in part, through the use of computer readable code, including general programming languages (such as C or C++), hardware description languages (HDL) including Verilog HDL, VHDL, Altera HDL (AHDL) and so on, or other available programming and/or schematic capture tools (such as circuit capture tools). This computer readable code can be disposed in any known computer usable medium including semiconductor, magnetic disk, optical disk (such as CD-ROM, DVD-ROM) and as a computer data signal embodied in a computer usable (e.g., readable) transmission medium (such as a carrier wave or any other medium including digital, optical, or analog-based medium). As such, the code can be transmitted over communication networks including the Internet and intranets. It is understood that the functions accomplished and/or structure provided by the systems and techniques described above can be represented in a core (such as a GPU core) that is embodied in program code and can be transformed to hardware as part of the production of integrated circuits.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for optimizing data processing on a single instruction multiple data (SIMD) core comprising a plurality of ALUs, the method comprising:
processing units of data within a working domain by the plurality of ALUs, wherein processing includes the plurality of ALUs executing in parallel within the persistent thread; and
each of the plurality of ALUs processing said unites of data until the processing of the working domain has finished.

2. The method of claim 1, wherein processing includes a plurality of working items and wherein one working item retrieves another unit of data each time one of the plurality of ALUs completes processing one unit of data.

3. The method of claim 1, wherein data in each unit of data may cause each ALU to complete processing each unit of data at a different time.

4. The method of claim 1, wherein the working items share a memory space in a local memory cache.

5. The method of claim 3, wherein the retrieving units of data further comprises each working item performing an atomic operation in the local memory cache to select the unit of data.

6. The method of claim 4, wherein each working item uses the local memory cache to obtain uninterrupted access to the selected unit of data selected.

7. The method of claim 1, further comprising receiving processed units of data on a displaying device.

8. The method of claim 1, further comprising terminating a wavefront after all working items have been terminated.
A system for optimizing data processing on a single instruction multiple data (SIMD) core comprising a plurality of ALUs, the system comprising:
a plurality of ALUs configured to process units of data within a working domain, wherein the plurality of ALUs execute in parallel within the persistent thread; and
each of the plurality of ALUs configured to processes said unites of data until the processing of the working domain has finished.

9. The system of claim 10, further comprising a plurality of working items configured to retrieve another unit of data each time one of the plurality of ALU completes processing one unit of data.

10. The system of claim 8, wherein data in the unit of data may cause each working item to complete processing each unit of data at a different time.

11. The system of claim 8, further comprising:
a local shared memory wherein the working items share a memory space to determine the units of data that require processing.

12. The system of claim 10, wherein each working item performs an atomic operation in the local shared memory to select the unit of data.

13. The system of claim 11, wherein each working item uses the local shared memory to obtain uninterrupted access to the selected unit of data.

14. The system of claim 8, further comprising a displaying device configured to receive processed units of data.

15. An article of manufacture including a computer-readable medium having instructions stored thereon that, when executed by a computing device, cause said computing device to optimize data processing on a single instruction multiple data (SIMD) core comprising a plurality of ALUs, comprising:
processing units of data within a working domain by the plurality of ALUs, wherein processing includes the plurality of ALUs executing in parallel within the persistent thread; and
each of the plurality of ALUs processing said unites of data until the processing of the working domain has finished.

16. The article of manufacture claim 15, wherein processing includes a plurality of working items and wherein one working item retrieves another unit of data each time one of the plurality of ALUs completes processing one unit of data.

17. The article of manufacture of claim 14, wherein data in each unit of data may cause each working item to complete executing each unit of data at a different time.

18. The article of manufacture of claim 14, further comprising receiving processed units of data on a displaying device.

19. The article of manufacture of claim 14, further comprising terminating a wavefront after all working items have been terminated.

20. A computer-readable medium carrying one or more sequences of one or more instructions for execution by one or more processors to perform a method for to optimize data processing on a single instruction multiple data (SIMD) core comprising a plurality of ALUs, the computer-readable medium comprising:
processing units of data within a working domain by the plurality of ALUs, wherein processing includes the plurality of ALUs executing in parallel within the persistent thread; and
each of the plurality of ALUs processing said unites of data until the processing of the working domain has finished.

21. The computer-readable medium of claim 20, wherein processing includes a plurality of working items and wherein one working item retrieves another unit of data each time one of the plurality of ALUs completes processing one unit of data.

22. The computer-readable medium of claim 20, wherein data in each unit of data may cause each ALU to complete processing each unit of data at a different time.

23. The computer-readable medium of claim 20, wherein the working items share a memory space in a local memory cache.

24. The computer-readable medium of claim 23, wherein the retrieving units of data further comprises each working item performing an atomic operation in the local memory cache to select the unit of data.

25. The computer-readable medium of claim 20, further comprising receiving processed units of data on a displaying device.
